(19) United States
(12) Patent Application Publication
(10) Pub. No.: US 2024/0167453 A1
(43) Pub. Date: May 23, 2024

(54) MODELING METHOD AND DEVICE OF FLOATING WIND TURBINE

(71) Applicants: NORTH CHINA ELECTRIC POWER UNIVERSITY, Beijing (CN); HUANENG GROUP R & D CENTER CO LTD, Beijing (CN)

(72) Inventors: Fang FANG, Beijing (CN); Ziqiu SONG, Beijing (CN); Yang HU, Beijing (CN); Jizhen LIU, Beijing (CN); Xiaojiang GUO, Beijing (CN); Qinghua WANG, Beijing (CN); Jiantao ZHENG, Beijing (CN)

(21) Appl. No.: 18/131,483

(22) Filed: Apr. 6, 2023

(30) Foreign Application Priority Data
Nov. 15, 2022 (CN) 2022114205779

(51) Int. Cl. F03D 7/04; F03D 13/25

(52) U.S. Cl. CPC F03D 7/045; F03D 13/25; F05B 2240/93; F05B 2260/84; F05B 2270/32; F05B 2270/327; F05B 2270/328; F05B 2270/335; F05B 2270/705

(57) ABSTRACT

Provided are modeling method and device of a floating wind turbine, which relate to the technical field of wind turbine modeling. The modeling method and device of a floating wind turbine can acquire pre-set state variables and input variables of the floating wind turbine, construct a nonlinear model based on the state variables and the input variables, and establish a control-oriented linear parameter varying model corresponding to the nonlinear model according to the nonlinear model, so as to control the floating wind turbine based on the control-oriented linear parameter varying model. The nonlinear model comprises: a drivetrain subsystem model, a tower subsystem model, a floating platform subsystem model, and a mooring subsystem model.

### CROSS-REFERENCE TO RELATED APPLICATION

The present disclosure claims the priority to the Chinese patent application with the filing No. 202211420577.9, filed on Nov. 15, 2022 with the State Intellectual Property Office of China, the contents of which are incorporated by reference herein in entirety.

### TECHNICAL FIELD

The present disclosure relates to the technical field of wind turbine modeling, and in particular, to a modeling method and a device of a floating wind turbine.

### BACKGROUND ART

With large-scale installation and gradual saturation of onshore and coastal wind turbines in recent years, and noise and visual influences and even traffic influence to human beings caused by large-scale onshore or coastal wind turbines, using a floating offshore wind turbine (FOWT) to acquire wind energy has become an inevitable choice.

The floating wind turbine supports a deep-water marine wind turbine by applying a floating platform, and has main advantages of: (1) a wide range of applicable water depth; 2) better flexibility in terms of deployment; (3) capability of installing a high-power wind generator; and 4) a lower cost for deeper waters.

However, the floating platform of the FOWT adds at least six degrees of freedom to the whole wind power system, and the bad deep sea environment aggravates nonlinearity of a coupling system, so that the control difficulty of the FOWT is increased. The stable and safe operation of the FOWT system requires the control over power, structure, and load, and coordination control therebetween under various operating conditions, and requires a more advanced and complex optimized control strategy, while the advanced control strategy requires an effective model as support, which model needs to be both accurate and simple, and can reduce calculation complexity and implementation difficulty of the model on the premise of meeting the model accuracy required by the control.

However, the models of wind turbines currently used are mostly models of onshore wind turbines, cannot reflect characteristics of the floating wind turbines, and even for the models of the floating wind turbines, they have relatively single applicability, and can hardly be adapted to most floating wind turbines.

### SUMMARY

In view of this, the present disclosure aims at providing a modeling method and a device of a floating wind turbine, so as to alleviate the above technical problems.

In a first aspect, an embodiment of the present disclosure provides a modeling method of a floating wind turbine, wherein the method includes steps of: acquiring pre-set state variables and input variables of the floating wind turbine, wherein the state variables are used to describe a state of the floating wind turbine, and the state variables include mechanical structure-related variables and electricity generation power-related variables; and the input variables include control input variables and environment input variables; constructing a nonlinear model based on the state variables and the input variables, wherein the nonlinear model includes: a drivetrain subsystem model, a tower subsystem model, a floating platform subsystem model, and a mooring subsystem model; and establishing a control-oriented linear parameter varying model corresponding to the nonlinear model according to the nonlinear model so as to control the floating wind turbine based on the control-oriented linear parameter varying model.

In combination with the first aspect, an embodiment of the present disclosure provides a first possible implementation of the first aspect, wherein the above mechanical structure-related variables include a horizontal surge translation of the platform, a pitch tilting rotation angle of the platform, a pitch tilting rotation angle of the tower, and first order derivatives of the horizontal surge translation of the platform, the pitch tilting rotation angle of the platform, and the pitch tilting rotation angle of the tower with respect to time; the electricity generation power-related variables include: a rotor speed, a pitch angle, and a generator electromagnetic torque; the control input variables include: a reference pitch angle and a reference generator electromagnetic torque; the environment input variables include: a horizontal reference wind speed measured at a nacelle of the floating wind turbine and a force of waves acting on the platform; a state matrix corresponding to the state variables is expressed as:
x=[ωᵣ, β, Tₑ, θₜₚ, θₚₚ, ξₛᵤ, \dot{θ}ₜₚ, \dot{θ}ₚₚ, \dot{ξ}ₛᵤ]^{T}, wherein ωᵣ represents the rotor speed, β represents the pitch angle, Tₑ represents the generator electromagnetic torque, ξₛᵤ represents the horizontal surge translation of the platform, θₚₚ represents the pitch tilting rotation angle of the platform, θₜₚ represents the pitch tilting rotation angle of the tower, \dot{θ}ₜₚ, \dot{θ}ₚₚ, \dot{ξ}ₛᵤ respectively represent the first order derivatives of the pitch tilting rotation angle of the tower, the pitch tilting rotation angle of the platform, and the horizontal surge translation of the platform with respect to time; an input matrix corresponding to the input variables is expressed as:
u=[u_{c}^{T}, uₑ^{T}]^{T}=[β_{ref}, T_{ref}, v_{w}, F_{wave}]^{T}, wherein u_{c} and uₑ are matrixes of the control input variables and the environment input variables, respectively, β_{ref} represents the reference pitch angle, T_{ref} represents the reference generator electromagnetic torque, v_{w} represents the horizontal reference wind speed measured at the nacelle of the floating wind turbine, and F_{wave} represents a force of waves acting on the platform.

In combination with the first possible implementation of the first aspect, an embodiment of the present disclosure provides a second possible implementation of the first aspect, wherein the above drivetrain subsystem model is configured to ensure torque balance of the floating wind turbine; the step of constructing a nonlinear model based on the state variables and the input variables includes: extracting the rotor speed ωᵣ and the generator electromagnetic torque Tₑ among the electricity generation power-related variables; and establishing the drivetrain subsystem model according to the following formula:
\dot{ω}ᵣ=(Tᵣ−B_{d}ωᵣ−N_{g}Tₑ)/(Jᵣ+N_{g}²J_{g}), wherein Tᵣ represents an aerodynamic torque of the floating wind turbine acquired from wind, B_{d} represents a damping constant, N_{g} represents a gear ratio, and Jᵣ and J_{g} are rotational inertia of the rotor and the generator, respectively.

In combination with the first possible implementation of the first aspect, an embodiment of the present disclosure provides a third possible implementation of the first aspect, wherein the above tower subsystem model is a nonlinear model established according to all torques acting on a center of gravity of the tower of the floating wind turbine; the step of constructing a nonlinear model based on the state variables and the input variables further includes: constructing the tower subsystem model according to the following formulas:

$${\ddot{θ}}_{tp} = \frac{1}{{J}_{t}} ( {m}_{t} {gh}_{tc} sin {θ}_{tp} - {T}_{C} + {\int }_{0}^{{h}_{r}} {F}_{wind} ( z ) dz ) \\ {T}_{C} = {K}_{t} ( {θ}_{tp} - {θ}_{pp} ) + {B}_{t} ( {\dot{θ}}_{tp} - {\dot{θ}}_{pp} )$$

in the above, Jₜ is rotational inertia of an equivalent tower; mₜ and h_{tc} represent mass and height of mass center of the tower; and Kₜ and Bₜ represent elastic stiffness and damping system of the tower.

In combination with the third possible implementation of the first aspect, an embodiment of the present disclosure provides a fourth possible implementation of the first aspect, wherein the floating platform subsystem model is a nonlinear model established according to all the moments acting on the floating platform of the floating wind turbine; the step of constructing a nonlinear model based on the state variables and the input variables further includes: acquiring moments acting on the floating platform, wherein the moments include a gravitational torque T_{G}, a buoyancy moment T_{B} of the floating platform, a mooring moment T_{M}, and an elasticity and damping moment T_{C} under coupling of the tower and the floating platform; and constructing the floating platform subsystem model based on the moments; the floating platform subsystem model is expressed as:

$${f}_{M}^{p} ( x , {u}_{c} , {u}_{e} ) = \sum {T}_{k} ( x , {u}_{c} , {u}_{e} ) / {J}_{p} \\ {\sum }_{k} {T}_{k} ( x , {u}_{c} , {u}_{e} ) = {T}_{B} + {T}_{C} + {T}_{G} + {T}_{M}$$

in the above, Jₚ represents rotational inertia of the floating platform; and Tₖ is all the moments acting on the floating platform.

In combination with the fourth possible implementation of the first aspect, an embodiment of the present disclosure provides a fifth possible implementation of the first aspect, wherein the above method further includes: acquiring an attribute information about the floating wind turbine, and calculating a gravitational torque according to the attribute information, wherein the gravitational torque is expressed as: T_{G}=−mₚgh_{pc} sin θₚₚ; and mₚ and h_{pc} represent mass and height of mass center of the floating platform, respectively.

In combination with the fifth possible implementation of the first aspect, an embodiment of the present disclosure provides a sixth possible implementation of the first aspect, wherein the above step of constructing a nonlinear model based on the state variables and the input variables further includes: acquiring a simplified model information about a mooring system of the floating wind turbine, and acquiring a force and a moment of a mooring cable in the mooring system acting on the floating platform based on the simplified model information; extracting the horizontal surge translation in the state variables, and calculating a relationship between a change length of the mooring cable and the horizontal surge translation according to the horizontal surge translation, so as to establishing a catenary equation; calculating an angle between the mooring cable and the floating platform according to the catenary equation and parameters of the mooring cable; and constructing the mooring subsystem model according to the input variables and the angle, wherein the mooring subsystem model is configured to represent a dynamic of the horizontal surge translation of the floating platform.

In combination with the sixth possible implementation of the first aspect, an embodiment of the present disclosure provides a seventh possible implementation of the first aspect, wherein the above step of establishing a control-oriented linear parameter varying model corresponding to the nonlinear model according to the nonlinear model includes: establishing a linear parameter varying model of the floating wind turbine at a steady-state operating condition point according to the nonlinear model, wherein the linear parameter varying model expression is as follows:

$$\{ \begin{matrix}δ \dot{x} = {\overline{A}}_{i} δ x + {\overline{B}}_{i}^{c} δ {u}_{c} + {\overline{B}}_{i}^{e} δ {u}_{e} \\ δ y = {C}_{i} δ x\end{matrix}$$

in the above, x is a state matrix corresponding to the state variables, u_{c} and uₑ are matrixes of the control input variables and the environment input variables, respectively, y is an output matrix, and Āᵢ, B̅ᵢ^{c}, and B̅ᵢ^{e} are partial derivatives of the nonlinear model at an i-th steady-state operating condition point, Ci represents an output matrix of the nonlinear model at the i-th steady-state operating condition point, and δ represents a deviation of a current value of the variable following thereafter from a value in the steady-state operating condition.

In a second aspect, an embodiment of the present disclosure further provides a modeling device of a floating wind turbine, wherein the device includes: a variable acquiring module, configured to acquire pre-set state variables and input variables of the floating wind turbine, wherein the state variables are used to describe a state of the floating wind turbine, and the state variables include mechanical structure-related variables and electricity generation power-related variables; and the input variables include control input variables and environment input variables; a first constructing module, configured to construct a nonlinear model based on the state variables and the input variables, wherein the nonlinear model includes: a drivetrain subsystem model, a tower subsystem model, a floating platform subsystem model, and a mooring subsystem model; and a second constructing module, configured to establish a control-oriented linear parameter varying model corresponding to the nonlinear model according to the nonlinear model, so as to control the floating wind turbine based on the control-oriented linear parameter varying model.

In a third aspect, an embodiment of the present disclosure further provides an electronic equipment, including a processor, a storage medium, and a bus, wherein the storage medium stores machine-readable instructions executable by the processor, and when the electronic equipment is running, the processor is in communication with the storage medium via the bus, and the processor executes the machine-readable instructions, so as to implement the steps of the method according to the first aspect.

In a fourth aspect, an embodiment of the present disclosure further provides a computer-readable storage medium, wherein the computer-readable storage medium stores a computer program, and the computer program, when executed by the processor, implements the steps of the above method according to the first aspect.

The embodiments of the present disclosure bring about the following beneficial effects:

The modeling method and device of a floating wind turbine provided in the embodiments of the present disclosure can acquire the pre-set state variables and input variables of the floating wind turbine, construct the nonlinear model based on the state variables and the input variables, and establish the control-oriented linear parameter varying model corresponding to the nonlinear model according to the nonlinear model, so as to control the floating wind turbine based on the control-oriented linear parameter varying model. In addition, the nonlinear model in the embodiments of the present disclosure includes: the drivetrain subsystem model, the tower subsystem model, the floating platform subsystem model, and the mooring subsystem model, covers a variety of properties of the floating wind turbine, can both keep the calculation complexity of the model in a moderate level on the premise of satisfying the model accuracy, and provide suitable and reliable model support for the design of the controller of the floating wind turbine, improving the control performance of the floating wind turbine.

Other features and advantages of the present disclosure will be illustrated in the following description, and partially become obvious from the description, or understood by implementing the present disclosure. The objectives and other advantages of the present disclosure are realized and obtained from the description, the claims, and the structures specifically indicated in the drawings.

In order to make the above objectives, the features, and the advantages of the present disclosure more obvious and understandable, preferred embodiments are specifically illustrated to make detailed descriptions below in conjunction with the drawings attached.

### BRIEF DESCRIPTION OF DRAWINGS

In order to illustrate the technical solutions in the embodiments of the present disclosure or the related art more clearly, the drawings that need to be used in the description of the embodiments or the prior art are briefly introduced as follows. Obviously, the drawings in the following description show some embodiments of the present disclosure. For those skilled in the art, other drawings can also be obtained according to these drawings without making any creative efforts.

FIG. 1 is a flowchart of a modeling method of a floating wind turbine provided in an embodiment of the present disclosure;

FIG. 2 is a simplified schematic diagram of a mooring system provided in an embodiment of the present disclosure;

FIG. 3 is a block diagram of a control-oriented linear parameter varying model provided in an embodiment of the present disclosure;

FIG. 4 is a schematic diagram of a simulation result provided in an embodiment of the present disclosure;

FIG. 5 is a schematic diagram of another simulation result provided in an embodiment of the present disclosure;

FIG. 6 is a schematic diagram of another simulation result provided in an embodiment of the present disclosure;

FIG. 7 is a structural schematic diagram of a modeling device of a floating wind turbine provided in an embodiment of the present disclosure; and

FIG. 8 is a structural schematic diagram of electronic equipment provided in an embodiment of the present disclosure.

### DETAILED DESCRIPTION OF EMBODIMENTS

In order to make objectives, technical solutions, and advantages of embodiments of the present disclosure clearer, the technical solutions in the present disclosure will be described below clearly and completely in conjunction with the drawings, and apparently, some but not all embodiments of the present disclosure are described. All of other embodiments, obtained by a person skilled in the art based on the embodiments of the present disclosure without making any creative efforts, shall fall into the scope of protection of the present disclosure.

At present, existing modeling methods of a floating wind turbine mainly model a wind turbine of a certain kind of platform, and have relatively single applicability. In addition, the existing modeling methods of a floating wind turbine involve a relatively high degree of freedom (DOF) of the floating wind turbine, which are complex in calculation, require a relatively long time for calculation, and cannot be adapted to designs of advanced controllers; or the modeling methods of a floating wind turbine are simplified too much and relatively simple, involve fewer DOFs of the floating wind turbine, and can hardly fully simulate properties of operation of the floating wind turbine in deep sea, thus, the advanced controller designed cannot achieve very high performances.

Based on this, embodiments of the present disclosure provide a modeling method and a device of a floating wind turbine, which take moderate degree of freedom into consideration so as to be adapted to most modeling methods of a floating wind turbine.

For ease of understanding of the present embodiment, firstly, a modeling method of a floating wind turbine disclosed in an embodiment of the present disclosure is introduced in detail.

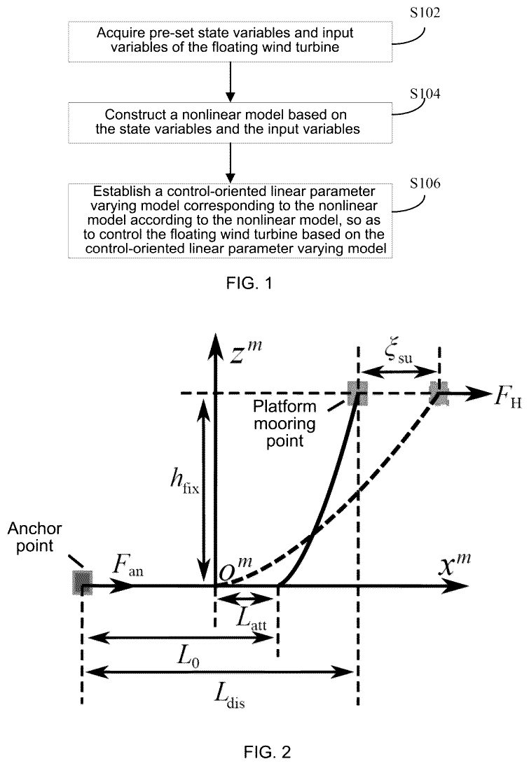

In a possible implementation, an embodiment of the present disclosure provides a modeling method of a floating wind turbine, and a flowchart of a modeling method of a floating wind turbine is shown in FIG. 1, wherein the method includes the following steps:
step S102, acquiring pre-set state variables and input variables of the floating wind turbine;
in the above, in the embodiment of the present disclosure, the state variables are used to describe a state of the floating wind turbine, and the state variables include mechanical structure-related variables and electricity generation power-related variables; and the input variables include control input variables and environment input variables;
step S104, constructing a nonlinear model based on the state variables and the input variables;
in the above, in the embodiment of the present disclosure, the nonlinear model includes: a drivetrain subsystem model, a tower subsystem model, a floating platform subsystem model, and a mooring subsystem model; and
step S106, establishing a control-oriented linear parameter varying model corresponding to the nonlinear model according to the nonlinear model, so as to control the floating wind turbine based on the control-oriented linear parameter varying model.

The modeling method of a floating wind turbine provided in the embodiment of the present disclosure can acquire the pre-set state variables and input variables of the floating wind turbine, construct the nonlinear model based on the state variables and the input variables, and establish the control-oriented linear parameter varying model corresponding to the nonlinear model according to the nonlinear model, so as to control the floating wind turbine based on the control-oriented linear parameter varying model. In addition, the nonlinear model in the embodiment of the present disclosure includes: the drivetrain subsystem model, the tower subsystem model, the floating platform subsystem model, and the mooring subsystem model, covers a variety of properties of the floating wind turbine, and can both keep the calculation complexity of the model in a moderate level on the premise of satisfying the model accuracy, and provide suitable and reliable model support for the design of the controller of the floating wind turbine, improving the control performance of the floating wind turbine.

In practical use, considering an installation environment of the floating wind turbine, it is usually assumed that the floating wind turbine and the platform are flexibly connected. In this way, compared with a model assumed with a single rigid body, influences of waves on output power and fatigue load can be more accurately simulated by a coupling mechanism; assuming that a tower and platform of the floating wind turbine have relatively small displacement, and assuming that the floating wind turbine is on a windward/waveward side, based on such assumptions, left and right bending motions of the tower and horizontal swinging, heaving, rolling and tilting, and yaw motions of the platform are microscopic and can be ignored.

Based on the above assumptions, in the embodiment of the present disclosure, 9 state variables are selected to describe the floating wind turbine, and these state variables are generally classified into mechanical structure-related variables and electricity generation power-related variables.

Specifically, the mechanical structure-related variables include a horizontal surge translation of the platform, a pitch tilting rotation angle of the platform, a pitch tilting rotation angle of the tower; and first order derivatives of the horizontal surge translation of the platform, the pitch tilting rotation angle of the platform, and the pitch tilting rotation angle of the tower with respect to time;

Further, the above electricity generation power-related variables in the embodiment of the present disclosure include: a rotor speed, a pitch angle, and a generator electromagnetic torque.

In specific implementation, in the embodiment of the present disclosure, the mechanical structure-related variables selected above can accurately reflect dynamic coupling motions of a floating platform, the tower, and the mooring system, wherein the pitch angle of blades can adjust wind energy capturing efficiency of the floating wind turbine, the rotator rotating speed can represent a situation state of wind energy conversion, and can be controlled by a generator electromagnetic torque in a variable speed fan. Therefore, in the embodiment of the present disclosure, a state matrix corresponding to the state variables is expressed as:

x=[ωᵣ,β,Tₑ,θₜₚ,θₚₚ,ξₛᵤ,\dot{θ}ₜₚ,\dot{θ}ₚₚ,\dot{ξ}ₛᵤ]^{T};

In the above, ωᵣ represents the rotor speed, β represents the pitch angle, Tₑ represents the generator electromagnetic torque, ξₛᵤ represents the horizontal surge translation of the platform, θₚₚ represents the pitch tilting rotation angle of the platform, θₜₚ represents the pitch tilting rotation angle of the tower, \dot{θ}ₜₚ, \dot{θ}ₚₚ, \dot{ξ}ₛᵤ respectively represent the first order derivatives of the pitch tilting rotation angle of the tower, the pitch tilting rotation angle of the platform, and the horizontal surge translation of the platform with respect to time, wherein the above platform refers to the floating platform of the floating wind turbine.

Further, the input variables in the embodiment of the present disclosure include the control input variables and the environment input variables, wherein the control input variables are generally designed and calculated from the controller, generally including: a reference pitch angle and a reference generator electromagnetic torque; and the environment input variables include: a horizontal reference wind speed measured at a nacelle of the floating wind turbine and a force of waves acting on the platform.

Moreover, an input matrix corresponding to the input variables in the embodiment of the present disclosure is expressed as:

u=[u_{c}^{T},uₑ^{T}]^{T}=[β_{ref},T_{ref},v_{w},F_{wave}]^{T};
in the above, u_{c} and uₑ are matrixes of the control input variables and the environment input variables, respectively; β_{ref} represents the reference pitch angle; T_{ref} represents the reference generator electromagnetic torque; v_{w} represents the horizontal reference wind speed measured at the nacelle of the floating wind turbine; and F_{wave} represents the force of waves acting on the platform.

Generally, in the embodiment of the present disclosure, a pitch angle actuator and a generator electromagnetic torque execution unit serve as a servo module, and can be modeled as a first order inertial link with amplitude limiting and speed limiting; therefore, the above pitch angle and the generator electromagnetic torque also can be expressed as:

\dot{β}=(β_{ref}−β)/τₚ,0≤β≤90°,|\dot{β}|≤β_{dmax}

\dot{T}ₑ=(T_{ref}−Tₑ)/τₑ,0≤Tₑ≤Tₘₐₓ,|\dot{T}ₑ|≤T_{dmax}

In the above, τₚ and τₑ represent equivalent time constants of the pitch angle actuator and the generator electromagnetic torque execution unit, respectively; β_{dmax} represents the maximum rate of change of the pitch angle actuator; Tₘₐₓ and T_{dmax} represent the maximum value and the maximum rate of the generator electromagnetic torque execution unit, respectively.

Further, an aerodynamic torque of the floating wind turbine acquired from wind can be expressed as:

Tᵣ=0.5ρₐAᵣ cos θₜₚCₚ(λ,β)vᵢₙ³/ωᵣ

In the above, ρₐ is air density; vᵢₙ is a wind speed actually captured by the rotor; Aᵣ is an area swept by the rotor; Cₚ is a wind energy utilization factor; and λ is a tip speed ratio.

In view of shearing of wind, the force of the wind acting on the tower of the floating wind turbine can be expressed as:

$${F}_{wind} ( z ) = \{ \begin{matrix}{F}_{wind , x} , z = {h}_{r} \\ \frac{1}{2} {ρ}_{a} D ( z ) {{v}_{w}^{2} ( z / {h}_{r} )}^{0.23}\end{matrix}$$

In the above, D(z) represents an outer diameter when a tower height is z; hᵣ represents nacelle height; and F_{wind,x} represents force of wind acting on the blades and the nacelle, which can be calculated by using blade element momentum.

Further, considering that waves consist of sine waves of multiple frequencies, directions, and phase angles in the sea, condition of waves can be expressed by Pierson-Moskowitz spectrum:

$${S}_{PM} ( f ) = \frac{{α}_{PM} {g}^{2}}{{( 2 π )}^{4} {f}^{5}} exp [ - 1.25 {( f / {f}_{P} )}^{- 4} ]$$

In the above, α_{PM} is Phillips constant, equal to 0.0081; f is wave frequency, f_{P} is peak wave frequency; and g is gravitational acceleration. For each water particle, a horizontal velocity can be calculated using Airy wave theory:

$${v}_{p} ( x , z ) = {A}_{w} ω \frac{cosh [ {N}_{w} ( z + {d}_{w} ) ]}{sinh {N}_{w} {d}_{w}} sin ( ω t - {N}_{w} x )$$

In the above, A_{w} represents wave amplitude; N_{w} represents the number of waves; d_{w} represents water depth; and z represents depth of the water particles. For a cylinder in water, Morison equation gives an estimation calculation method for force applied thereto:

$${F}_{wave} = {\int }_{0}^{{d}_{w}} ( \frac{1}{2} {ρ}_{w} {C}_{d} {D}_{t} ( z ) \vert {v}_{p} \vert {v}_{p} + {ρ}_{w} {C}_{a} {V}_{c} ( z ) {\dot{v}}_{p} ) dz$$

In the above, C_{d} and Cₐ are resistance and inertia coefficients of the platform, respectively; and Dₜ and V_{c} are cross-sectional area and volume of platform cylinder, respectively.

Therefore, the input matrix corresponding to the above input variables may be expressed as:

u=[u_{c}^{T},uₑ^{T}]^{T}=[β_{ref},T_{ref},v_{w},F_{wave}]^{T}.

Further, based on the above state variables and input variables, a process of constructing the nonlinear model is described in detail below:

### (1) Drivetrain Subsystem Model

In the embodiment of the present disclosure, the drivetrain subsystem model in the above nonlinear model is configured to ensure torque balance of the floating wind turbine; generally, the drivetrain subsystem model is constructed according to a relationship between the rotator rotating speed and the torque, wherein the drivetrain subsystem model ensures torque balance, and usually can be simplified into a simple mass block with a damping constant B_{d} and a gear ratio N_{g}:
therefore, when establishing the drivetrain subsystem model, the rotor speed ωᵣ and the generator electromagnetic torque Tₑ among the electricity generation power-related variables can be extracted; and the drivetrain subsystem model is established according to the following formula:

\dot{ω}ᵣ=(Tᵣ−B_{d}ωᵣ−N_{g}Tₑ)/(Jᵣ+N_{g}²J_{g})

In the above, Tᵣ represents the aerodynamic torque of the floating wind turbine acquired from wind, B_{d} represents the damping constant, N_{g} represents the gear ratio, and Jᵣ and J_{g} are rotational inertia of the rotor and the generator, respectively.

### (2) Tower Subsystem Model

The above tower subsystem model in the embodiment of the present disclosure is a nonlinear model established according to all the torques acting on the center of gravity of the tower of the floating wind turbine; specifically, in the embodiment of the present disclosure, elasticity and damping influences under gravity, wind power, tower, and platform coupling are taken into consideration, therefore, the tower subsystem model can be constructed according to the following formula for implementation:

$${\ddot{θ}}_{tp} = \frac{1}{{J}_{t}} ( {m}_{t} {gh}_{tc} sin {θ}_{tp} - {T}_{C} + {\int }_{0}^{{h}_{r}} {F}_{wind} ( z ) dz )$$

$${T}_{C} = {K}_{t} ( {θ}_{tp} - {θ}_{pp} ) + {B}_{t} ( {\dot{θ}}_{tp} - {\dot{θ}}_{pp} )$$

In the above, Jₜ is rotational inertia of equivalent tower; mₜ and h_{tc} represent mass and height of mass center of the tower; and Kₜ and Bₜ represent elastic stiffness and damping system of the tower.

### (3) Floating Platform Subsystem Model

The above floating platform subsystem model in the embodiment of the present disclosure is a nonlinear model established according to all the moments acting on the floating platform of the floating wind turbine, mainly including a gravitational torque T_{G}, a buoyancy moment T_{B} of the floating platform, a mooring moment T_{M}, and elasticity and damping moment T_{C} under the coupling of the tower and the floating platform.

Therefore, when constructing the floating platform subsystem model, the moment acting on the floating platform can be acquired; and the moment in this case includes the gravitational torque T_{G}, the buoyancy moment T_{B} of the floating platform, the mooring moment T_{M}, and the elasticity and damping moment T_{C} under the coupling of the tower and the floating platform;

The floating platform subsystem model constructed based on the above moments is expressed as:

$${f}_{M}^{p} ( x , {u}_{c} , {u}_{e} ) = \sum {T}_{k} ( x , {u}_{c} , {u}_{e} ) / {J}_{p}$$

$${\sum }_{k} {T}_{k} ( x , {u}_{c} , {u}_{e} ) = {T}_{B} + {T}_{C} + {T}_{G} + {T}_{M}$$

In the above, Jₚ represents the rotational inertia of the floating platform; and Tₖ is all the moments acting on the floating platform.

Further, with regard to the floating wind turbine, an inherent moment thereof is mainly composed of the above T_{G} and T_{C}, and can be directly calculated according to attributes of the floating wind turbine, wherein T_{C} can be described according to the formula in the foregoing tower subsystem model. When calculating the gravitational torque, attribute information about the floating wind turbine can be acquired, and the gravitational torque is calculated according to the attribute information, wherein in the embodiment of the present disclosure, the gravitational torque is expressed as:

T_{G}=−mₚgh_{pc} sin θₚₚ;
in the above, mₚ and h_{pc} represent mass and height of mass center of the floating platform, respectively.

Further, the buoyancy moment T_{B} and mooring moment T_{M} in the above can reflect a highly nonlinear coupling relationship between the waves, the platform, and a mooring cable. Moreover, in the embodiment of the present disclosure, it is assumed that a bottom cylinder of the platform is always under water and always submerged in water, for example, taking a semi-submersible floating platform as an example, the buoyancy moment T_{B} thereof is expressed as:

T_{B}=(F_{buo}^{L}−2F_{buo}^{R})Rₚ cos θₚₚ

In the above, superscripts L and R represent a left pontoon and a right pontoon of the platform, respectively; Rₚ represents a lower radius of the pontoon, and F_{buo}^{L} and F_{buo}^{R} represent buoyancy of the left and right pontoons, respectively, and can be further expressed as:

$$\{ \begin{matrix}{F}_{buo}^{L} = {ρ}_{w} g ( {V}_{0} - π {R}_{up}^{2} {R}_{p} sin {θ}_{pp} ) \\ {F}_{buo}^{R} = {ρ}_{w} g ( {V}_{0} - π {R}_{up}^{2} {R}_{p} sin {θ}_{pp} )\end{matrix}$$

In the above, ρ_{w} represents density of sea, V₀ represents an initial water discharge of the platform, and Rᵤₚ represents an upper radius of the pontoon.

### (4) Mooring Subsystem Model

In the embodiment of the present disclosure, when constructing the mooring subsystem model, it is usually assumed that a mooring cable of the mooring system is a standard catenary, with one end being connected to the platform, and one end being an anchor fixed to subsea soil. In order to facilitate understanding, FIG. 2 shows a simplified schematic diagram of a mooring system, and specifically, FIG. 2 shows a schematic diagram of a left mooring system, wherein a coordinate system o^{m}x^{m}z^{m} is a plane of the mooring cable, showing condition below sea level, and similarly, the mooring system on the right is in a similar situation. In the above, h_{fix} represents a distance from a platform connection point to seabed, L_{dis} represents an initial horizontal distance of the anchor to the platform connection point when the horizontal surge translation of the platform is 0, wherein when the mooring line is in an unstretched state, a part of the mooring cable stays on the seabed, L₀ represents an initial length staying on the seabed; and F_{H} and Fₐₙ represent horizontal tension of the mooring cable at the platform connection point and the anchor, respectively.

Based on the simplified schematic diagram shown in FIG. 2, when constructing the mooring subsystem model, simplified model information about the mooring system of the floating wind turbine can be acquired, for example, the information shown in FIG. 2 is acquired, and then force and moment of the mooring cable in the mooring system acting on the floating platform are acquired based on the simplified model information. In the above, in the embodiment of the present disclosure, the force of the mooring cable acting on the floating platform is expressed as follows:

$$\{ \begin{matrix}{F}_{line}^{L} = {F}_{H}^{L} \cdot {\{ 1 + {[ {μ}_{line} g ( {L}_{line} + {L}_{att}^{L} - {L}_{0} ) / {F}_{H}^{L} ]}^{2} \}}^{0.5} \\ {F}_{line}^{R} = {F}_{H}^{R} \cdot {\{ 1 + {[ {μ}_{line} g ( {L}_{line} + {L}_{att}^{R} - {L}_{0} ) / {F}_{H}^{R} ]}^{2} \}}^{0.5}\end{matrix}$$

In the above, Lₗᵢₙₑ and μₗᵢₙₑ represent the length and line density of the mooring cable, respectively; and Lₐₜₜ is change length of the mooring cable remaining on the seabed with respect to the original length when the horizontal surge translation of the platform changes.

The moment of the mooring system acting on the platform can be expressed as:

T_{M}=(2Fₗᵢₙₑ^{R} sin γₗᵢₙₑ^{R}−Fₗᵢₙₑ^{L} sin γₗᵢₙₑ^{L})Rₚ cos θₚₚ

In the above, γₗᵢₙₑ represents an angle at which the mooring cable is connected to the platform.

Further, the horizontal surge translation in the state variables is extracted, a relationship between the change length of the mooring cable and the horizontal surge translation is calculated according to the extracted horizontal surge translation, and a catenary equation is established; an angle between the mooring cable and the floating platform is calculated according to the catenary equation and parameters of the mooring cable; further, the mooring subsystem model is constructed according to the input variables and the angle, and the mooring subsystem model is configured to represent dynamic of the horizontal surge translation of the floating platform.

Specifically, in the embodiment of the present disclosure, establishing the catenary equation is to acquire a relationship between Lₐₜₜ and ξₛᵤ. Moreover, the catenary equation is expressed as:

y(x)=κ(cosh x/κ−1),κ=Fₐₙ(ξₛᵤ)/μₗᵢₙₑg

A line length equation of the catenary can be calculated as

sₗᵢₙₑ(x)=Fₐₙ(ξₛᵤ)|sinh(gx/Fₐₙ(ξₛᵤ))|/g

According to the parameters of the mooring cable and the catenary equation, the following equations can be obtained:

$$\{ \begin{matrix}κ ( cosh ( ( {L}_{dis} - {L}_{0} + {L}_{att}^{L} + {ξ}_{su} ) / κ ) - 1 ) = {h}_{fix} \\ κ ( cosh ( ( {L}_{0} + {L}_{att}^{R} + {ξ}_{su} - {L}_{dis} ) / κ ) - 1 ) = {h}_{fix}\end{matrix}$$

Therefore, when the horizontal surge translation ξₛᵤ is measured, Lₐₜₜ can be obtained by solving the above equations, and furthermore, the angle connecting the mooring cable and the platform can be calculated as:

$$\{ \begin{matrix}{γ}_{line}^{L} = {μ}_{line} {gs}_{line} ( {L}_{dis} - {L}_{0} + {L}_{att}^{L} + {ξ}_{su} ) / {F}_{an} \\ {γ}_{line}^{R} = {μ}_{line} {gs}_{line} ( {L}_{0} + {L}_{att}^{L} + {ξ}_{su} - {L}_{dis} ) / {F}_{an}\end{matrix}$$

Then, according to the dynamic of the mooring system, the dynamic of the horizontal surge translation of the platform can be expressed as:

\ddot{ξ}ₛᵤ=(F_{wave}−Fₗᵢₙₑ^{L} cos γₗᵢₙₑ^{L}+2Fₗᵢₙₑ^{R} cos γₗᵢₙₑ^{R} cos γ_{dis})/mₚ,
thus, the mooring subsystem model in the embodiment of the present disclosure is obtained.

Further, based on the above nonlinear model, when establishing the control-oriented linear parameter varying model, a linear parameter varying model of the floating wind turbine is established at a steady-state operating condition point according to the above nonlinear model; and the linear parameter varying model expression is as follows:

$$\{ \begin{matrix}δ \dot{x} = {\overline{A}}_{i} δ x + {\overline{B}}_{i}^{c} δ {u}_{c} + {\overline{B}}_{i}^{e} δ {u}_{e} \\ δ y = {C}_{i} δ x\end{matrix}$$

In the above, x is a state matrix corresponding to the above state variables, u_{c} and uₑ are matrixes of the control input variables and the environment input variables, respectively, y is an output matrix, and Āᵢ, B̅ᵢ^{c}, and B̅ᵢ^{e} are partial derivatives of the nonlinear model at an i-th steady-state operating condition point, the nonlinear model herein is any one of the above nonlinear models in the embodiments of the present disclosure, Ci represents an output matrix of the nonlinear model at the i-th steady-state operating condition point, and δ represents deviation of a current numerical value of the variable following thereafter from a numerical value in the steady-state operating condition.

In specific implementation, in the embodiments of the present disclosure, the above linear parameter varying model is also referred to as a system incremental state-space expression, and the above output matrix y is the output power and tower top displacement of the floating wind turbine.

Further, in the embodiments of the present disclosure, Āᵢ, B̅ᵢ^{c}, and B̅ᵢ^{e} in the above are also referred to as coefficient matrixes, and have the following calculation formulas:

$${\overline{A}}_{i} = \frac{\partial f}{\partial x} {\vert}_{( {x}_{i} , {u}_{i} )} , \qquad {\overline{B}}_{i}^{c} = \frac{\partial f}{\partial {u}_{c}} {\vert}_{( {x}_{i} , {u}_{i} )} , \qquad {\overline{B}}_{i}^{e} = \frac{\partial f}{\partial {u}_{e}} {\vert}_{( {x}_{i} , {u}_{i} )} ,$$

wherein f is generally a nonlinear mapping relationship between a partial derivative of the state variables and the state variables, the control input variables, and the environment input variables.

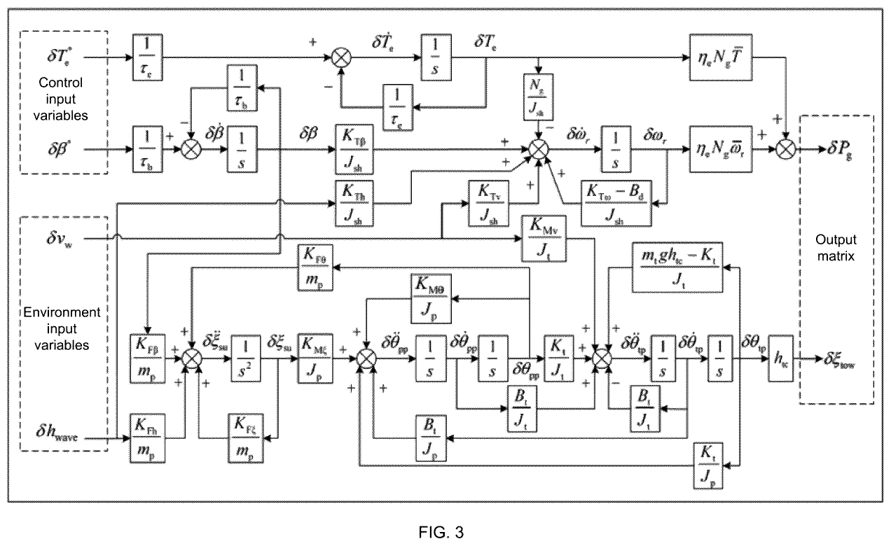

Further, for ease of understanding, FIG. 3 also shows a block diagram of a control-oriented linear parameter varying model, and as shown in FIG. 3, the control input variables and the environment input variables included in the input variables and the output matrix are respectively shown, and relevant parameters shown in FIG. 3 are calculated as follows:

$$( {K}_{T ω} , {K}_{T β} , {K}_{Tv} , {K}_{Th} ) = {( \frac{\partial {T}_{r}}{\partial {ω}_{r}} , \frac{\partial {T}_{r}}{\partial β} , \frac{\partial {T}_{r}}{\partial {v}_{w}} , \frac{\partial {T}_{r}}{\partial {h}_{wave}} )}_{( {x}_{i} , {u}_{i} )}$$

$$( {K}_{M θ} , {K}_{M ξ} ) = {( \frac{\partial {M}_{po}}{\partial {θ}_{pp}} , \frac{\partial {M}_{po}}{\partial {ξ}_{su}} )}_{( {x}_{i} , {u}_{i} )}$$

$$( {K}_{F θ} , {K}_{F ξ} , {K}_{Fh} , {K}_{F β} ) = {( \frac{\partial {F}_{0}}{\partial {θ}_{pp}} , \frac{\partial {F}_{0}}{\partial {ξ}_{su}} , \frac{\partial {F}_{0}}{\partial {h}_{wave}} , \frac{\partial {F}_{0}}{\partial β} )}_{( {x}_{i} , {u}_{i} )}$$

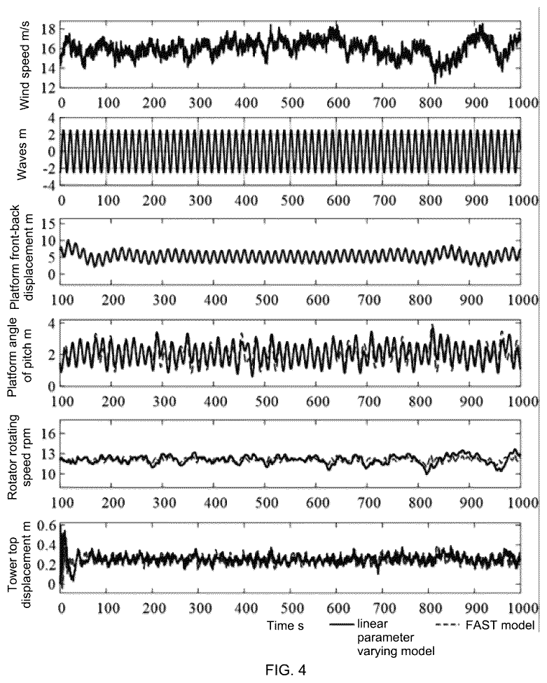

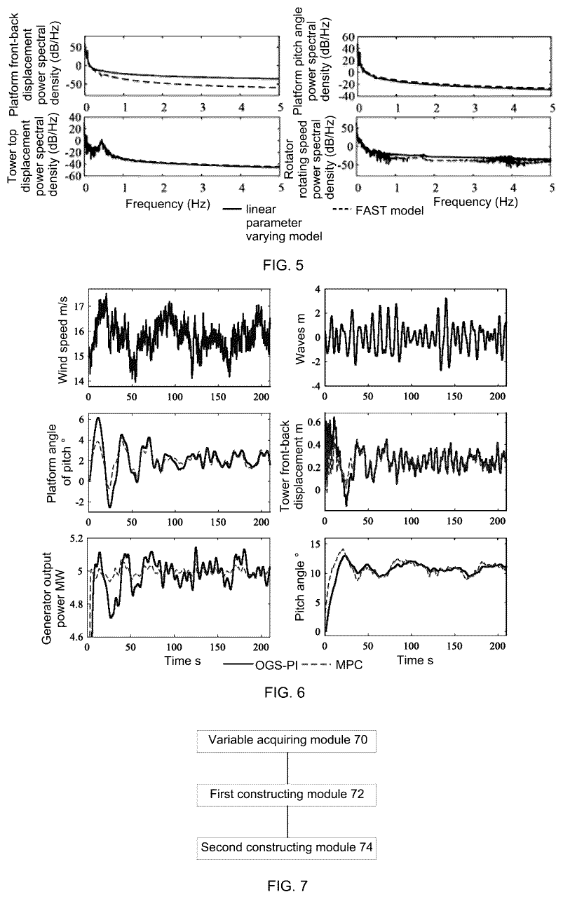

Moreover, the above control-oriented linear parameter varying model provided in the embodiments of the present disclosure may also be compared with a high-fidelity floating wind turbine model FAST in time domain and frequency domain, and comparison results are as shown in FIG. 4 and FIG. 5. Moreover, by using the control-oriented linear parameter varying model obtained in the embodiments of the present disclosure, a model prediction controller (MPC) can be further designed to control the floating wind turbine, and the operation result thereof can be compared with an optimal gain scheduling proportional integral (GSPI) controller in the prior art based on FAST for simulation verification, for example, a simulation sampling interval is 0.01 seconds.

Generally, wind used in the simulation is turbulent wind with a lifting amplitude of 12 m/s to 18 m/s, wave used is sine wave, and the simulation result is as shown in FIG. 6.

Specifically, in FIG. 4 and FIG. 5, simulation results of the linear parameter varying model in the embodiment of the present disclosure are shown, wherein a dashed line is a simulation result of the pre-set FAST model. It can be seen from FIG. 4 and FIG. 5 that the floating wind turbine with 9 degrees of freedom provided in the embodiments of the present disclosure may make accurate dynamic response to the floating wind turbine, which is similar to the response result of the FAST model with 44 degrees of freedom, and the difference is relatively small. It can be seen from the frequency domain diagram that for the linear parameter varying model established according to the method of the embodiment of the present disclosure, a spectrum of horizontal pitching and angle of pitch of the platform thereof has a peak at 0.067 Hz, which is corresponding to wave period of 15 s, further verifying the accuracy of the embodiments of the present disclosure.

It can be seen from FIG. 6 that MPC controller designed according to the linear parameter varying model established by the method provided in the embodiments of the present disclosure has a better performance than GSPI controller in reducing operation fluctuation of the system. With the MPC controller designed according to the model established by the method of the embodiments of the present disclosure, the generator power of the floating wind turbine is smoothed, the tower top displacement is suppressed, standard deviation of the generator power is reduced by 94.58 kW compared with GSPI, and standard deviation of the tower top displacement is reduced by 0.021 m compared with GSPI.

Further, on the basis of the above embodiments, an embodiment of the present disclosure provides a modeling device of a floating wind turbine, and a structural schematic diagram of a modeling device of a floating wind turbine is as shown in FIG. 7, wherein the device includes:
a variable acquiring module 70, configured to acquire pre-set state variables and input variables of the floating wind turbine, wherein the state variables are used to describe a state of the floating wind turbine, and the state variables include mechanical structure-related variables and electricity generation power-related variables; and the input variables include control input variables and environment input variables;
a first constructing module 72, configured to construct a nonlinear model based on the state variables and the input variables, wherein the nonlinear model includes: a drivetrain subsystem model, a tower subsystem model, a floating platform subsystem model, and a mooring subsystem model; and
a second constructing module 74, configured to establish a control-oriented linear parameter varying model corresponding to the nonlinear model according to the nonlinear model, so as to control the floating wind turbine based on the control-oriented linear parameter varying model.

The modeling device of a floating wind turbine provided in the embodiments of the present disclosure has the same technical features as the modeling method of a floating wind turbine provided in the above embodiments, so that it can also solve the same technical problems and achieve the same technical effects.

Further, an embodiment of the present disclosure further provides electronic equipment, including: a processor, a storage medium, and a bus, wherein the storage medium stores machine-readable instructions executable by the processor, wherein when the electronic equipment is running, the processor is in communication with the storage medium via the bus, and the processor executes the machine-readable instructions, so as to implement the steps of the above method.

Further, an embodiment of the present disclosure further provides a computer-readable storage medium, wherein the computer-readable storage medium stores a computer program, and the computer program, when executed by the processor, implement the steps of the above method.

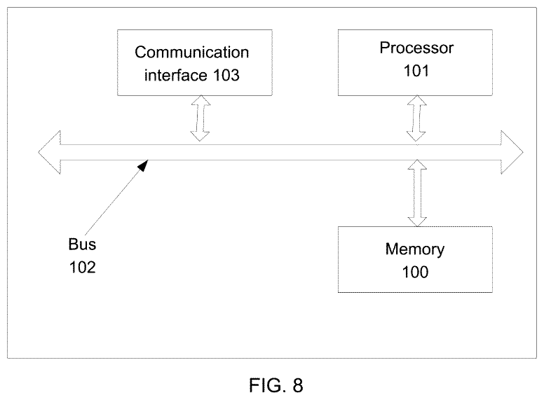

Further, an embodiment of the present disclosure further provides a structural schematic diagram of electronic equipment, as shown in FIG. 8, a structural schematic diagram of the electronic equipment is shown, wherein the electronic equipment includes a processor 101 and a memory 100, wherein the memory 100 stores computer-executable instructions that can be executed by the processor 101, and the processor 101 executes the computer-executable instructions so as to implement the above method.

In the implementation shown in FIG. 8, the electronic equipment further includes a bus 102 and a communication interface 103, wherein the processor 101, the communication interface 103, and the memory 100 are connected via the bus 102.

In the above, the memory 100 may include a high-speed random access memory (RAM), and also may include a non-volatile memory, for example, at least one disk memory. Communication connection between this system network element and at least one other network element is achieved through at least one communication interface 103 (possibly wired or wireless), wherein Internet, Wide Area Network, local network, Metropolitan Area Network and so on may be used. The bus 102 can be an ISA (Industrial Standard Architecture) bus, PCI (Peripheral Component Interconnect) bus or EISA (Extended Industry Standard Architecture) bus, etc. The bus 102 may be an address bus, a data bus, a control bus and so on. For ease of representation, the bus is represented merely with one two-way arrow in FIG. 8, but it does not mean that there is only one bus or one type of bus.

The processor 101 may be an integrated circuit chip with a signal processing function. In an implementation process, various steps of the above method may be completed by an integrated logic circuit of hardware in the processor 101 or instruction in a software form. The above processor 101 may be a general-purpose processor, including a central processing unit (CPU for short), a network processor (NP for short), etc., and also may be a digital signal processor (DSP for short), an application specific integrated circuit (ASIC for short), a field-programmable gate array (FPGA for short) or other programmable logic devices, discrete gates, transistor logic devices, or discrete hardware components. The general purpose processor may be a microprocessor or the processor also may be any conventional processor and so on. The steps in the method disclosed in combination with the embodiments of the present disclosure may be embodied as being directly carried out and completed by hardware decoding processor, or carried out and completed by hardware and software modules in the decoding processor. The software module may be located in a mature storage medium in the art such as a random access memory, a flash memory, a read-only memory, a programmable read-only memory or an electrically erasable programmable memory, and register. The storage medium is located in the memory, wherein the processor 101 reads the information in the memory, and completes the foregoing method in combination with its hardware.

A computer program product of the modeling method and device of a floating wind turbine provided in an embodiment of the present disclosure includes a computer-readable storage medium in which a program code is stored, and instructions included in the program code may be used to implement the method described in the method embodiment in the preceding. Reference may be made to the method embodiment for specific implementation, which will not be repeated redundantly herein.

A person skilled in the art could clearly know that for the sake of convenience and conciseness of description, reference can be made to corresponding processes in the above method embodiments for specific operation processes of the device described in the above, and they will not be repeated redundantly herein.

In addition, in the description of the embodiments of the present disclosure, unless otherwise specified and defined explicitly, terms “mount”, “join”, and “connect” should be construed in a broad sense, for example, a connection can be a fixed connection, a detachable connection, or an integrated connection; it can be a mechanical connection, and also can be an electrical connection; it can be a direct connection, an indirect connection through an intermediate medium, or an inner communication between two elements. For a person skilled in the art, specific meanings of the above-mentioned terms in the present disclosure can be understood according to specific circumstances.

If the function is realized in a form of software functional unit and is sold or used as an individual product, it may be stored in one computer readable storage medium. Based on such understanding, the essence of the technical solution of the present disclosure, a part of the technical solution which contributes to the related art, or a part of the technical solution can be embodied in the form of a software product. The computer software product is stored in a storage medium, including several instructions which are used to make a computer device (which may be a personal computer, a server, or a network device, etc.) implement all or part of the steps of the methods described in the various embodiments of the present disclosure. The aforementioned storage medium includes various media in which program codes can be stored, such as U disk, mobile hard disk, read-only memory (ROM), random access memory (RAM), diskette and compact disk.

In the description of the present disclosure, it should be noted that orientation or positional relationships indicated by terms such as “center”, “upper”, “lower”, “left”, “right”, “vertical”, “horizontal”, “inner”, and “outer” are based on orientation or positional relationships as shown in the drawings, merely for facilitating the description of the present disclosure and simplifying the description, rather than indicating or implying that related devices or elements have to be in the specific orientation, or configured and operated in a specific orientation, therefore, they should not be construed as limitation on the present disclosure. Besides, terms “first”, “second”, and “third” are merely for descriptive purpose, but should not be construed as indicating or implying importance in the relativity.

Finally, it should be noted that the above embodiments are merely specific embodiments of the present disclosure, for illustrating the technical solutions of the present disclosure, rather than limiting the present disclosure, and the scope of protection of the present disclosure should not be limited thereto. While the detailed description is made to the present disclosure with reference to the preceding embodiments, those ordinarily skilled in the art should understand that within the technical scope disclosed in the present disclosure, anyone familiar with the present technical field still can make modifications or readily envisage changes for the technical solutions recited in the preceding embodiments, or make equivalent substitutions to some of the technical features therein; these modifications, changes, or substitutions do not make the essence of the corresponding technical solutions depart from the spirit and scope of the technical solutions of the embodiments of the present disclosure, and they all should be covered within the scope of protection of the present disclosure. Therefore, the scope of protection of the present disclosure should be subject to the protection scope of the claims.

1. A modeling method of a floating wind turbine, for modeling floating wind turbine using a semi-submersible floating platform to support a deepwater offshore wind turbine, comprising steps of:
by one or more processors, acquiring pre-set state variables and input variables of the floating wind turbine, wherein the state variables are used to describe a state of the floating wind turbine, and the state variables comprise mechanical structure-related variables and electricity generation power-related variables; and the input variables comprise control input variables and environment input variables;
constructing a nonlinear model based on the state variables and the input variables, wherein the nonlinear model comprises: a drivetrain subsystem model, a tower subsystem model, a semi-submersible floating platform subsystem model, and a mooring subsystem model; and
establishing, according to the nonlinear model, a control-oriented linear parameter varying model corresponding to the nonlinear model, so as to control the floating wind turbine based on the control-oriented linear parameter varying model;
wherein the mechanical structure-related variables comprise a horizontal surge translation of the platform, a pitch tilting rotation angle of the platform, a pitch tilting rotation angle of the tower, and first order derivatives of the horizontal surge translation of the platform, the pitch tilting rotation angle of the platform, and the pitch tilting rotation angle of the tower with respect to time;
the electricity generation power-related variables comprise: a rotor speed, a pitch angle, and a generator electromagnetic torque;
the control input variables comprise: a reference pitch angle and a reference generator electromagnetic torque;
the environment input variables comprise: a horizontal reference wind speed measured at a nacelle of the floating wind turbine and a force of waves acting on the platform;
a state matrix corresponding to the state variables is expressed as:
x=[ωᵣ,β,Tₑ,θₜₚ,θₚₚ,ξₛᵤ,\dot{θ}ₜₚ,\dot{θ}ₚₚ,\dot{ξ}ₛᵤ]^{T},
where ωᵣ represents the rotor speed, β represents the pitch angle, Tₑ represents the generator electromagnetic torque, ξₛᵤ represents the horizontal surge translation of the platform, θₚₚ represents the pitch tilting rotation angle of the platform, θₜₚ represents the pitch tilting rotation angle of the tower, \dot{θ}ₜₚ, \dot{θ}ₚₚ, \dot{ξ}ₛᵤ respectively represent the first order derivatives of the pitch tilting rotation angle of the tower, the pitch tilting rotation angle of the platform, and the horizontal surge translation of the platform with respect to time; and
an input matrix corresponding to the input variables is expressed as:
u=[u_{c}^{T},uₑ^{T}]^{T}=[β_{ref},T_{ref},v_{w},F_{wave}]^{T},
where u_{c} and uₑ are matrixes of the control input variables and the environment input variables, respectively, β_{ref} represents the reference pitch angle, T_{ref} represents the reference generator electromagnetic torque, v_{w} represents the horizontal reference wind speed measured at the nacelle of the floating wind turbine, and F_{wave} represents a force of waves acting on the platform;
wherein the drivetrain subsystem model is configured to ensure a torque balance of the floating wind turbine; and
the step of constructing a nonlinear model based on the state variables and the input variables comprises:
extracting the rotor speed ωᵣ and the generator electromagnetic torque Tₑ among the electricity generation power-related variables; and establishing the drivetrain subsystem model according to the following formula:
\dot{ω}ᵣ=(Tᵣ−B_{d}ωᵣ−N_{g}Tₑ)/(Jᵣ+N_{g}²J_{g}),
where Tᵣ represents an aerodynamic torque of the floating wind turbine acquired from wind, B_{d} represents a damping constant, N_{g} represents a gear ratio, and Jᵣ and J_{g} are rotational inertia of the rotor and the generator, respectively.
wherein the tower subsystem model is a nonlinear model established according to all torques acting on a center of gravity of the tower of the floating wind turbine; and
the step of constructing a nonlinear model based on the state variables and the input variables further comprises:
constructing the tower subsystem model according to the following formulas:
$${\ddot{θ}}_{tp} = \frac{1}{{J}_{t}} ( {m}_{t} {gh}_{tc} sin {θ}_{tp} - {T}_{C} + {\int }_{0}^{{h}_{r}} {F}_{wind} ( 𝓏 ) d 𝓏 )$$
$${T}_{C} = {K}_{t} ( {θ}_{tp} - {θ}_{pp} ) + {B}_{t} ( {\dot{θ}}_{tp} - {\dot{θ}}_{pp} ) ,$$
where Jₜ is a rotational inertia of an equivalent tower; mₜ and h_{tc} represent a mass and a height of mass center of the tower; and Kₜ and Bₜ represent an elastic stiffness and damping system of the tower;
wherein the floating platform subsystem model is a nonlinear model established according to all moments acting on the floating platform of the floating wind turbine; and
the step of constructing a nonlinear model based on the state variables and the input variables further comprises:
acquiring the moments acting on the floating platform, wherein the moments comprise: a gravitational torque T_{C}, a buoyancy moment T_{B} of the floating platform, a mooring moment T_{M}, and an elasticity and damping moment T_{C} under coupling of the tower and the floating platform; and
constructing the floating platform subsystem model based on the moments,
wherein the floating platform subsystem model is expressed as:
$$\underline{{f}_{M}^{p} ( x , {u}_{c} , {u}_{e} ) = \sum {T}_{k} ( x , {u}_{c} , {u}_{e} ) / {J}_{p} . and}$$
$$\underline{{\sum }_{k} {T}_{k} ( x , {u}_{c} , {u}_{e} ) = {T}_{B} + {T}_{C} + {T}_{G} + {T}_{M}}$$
where Jₚ represents rotational inertia of the floating platform; and Tₖ is all the moments acting on the floating platform;
wherein the method further comprises:
acquiring an attribute information about the floating wind turbine, and calculating the gravitational torque according to the attribute information,
wherein the gravitational torque is expressed as: T_{G}=−mₚgh_{pc} sin θₚₚ; and mₚ and h_{pc} represent mass and height of mass center of the floating platform, respectively;
wherein the step of constructing a nonlinear model based on the state variables and the input variables further comprises:
acquiring a simplified model information about a mooring system of the floating wind turbine, and acquiring a force and a moment of a mooring cable in the mooring system acting on the floating platform based on the simplified model information, wherein one end of the mooring cable is connected to the platform, and another end being an anchor fixed to subsea soil;
extracting the horizontal surge translation in the state variables, and calculating a relationship between a change length of the mooring cable and the horizontal surge translation according to the horizontal surge translation, so as to establish a catenary equation;
calculating an angle between the mooring cable and the floating platform according to the catenary equation and parameters of the mooring cable; and
constructing the mooring subsystem model according to the input variables and the angle, wherein the mooring subsystem model is configured to represent a dynamic of the horizontal surge translation of the floating platform.

2. (canceled)

3. (canceled)

4. (canceled)

5. (canceled)

6. (canceled)

7. (canceled)

8. The method according to claim 1, wherein the step of establishing a control-oriented linear parameter varying model corresponding to the nonlinear model according to the nonlinear model comprises:
establishing the linear parameter varying model of the floating wind turbine at a steady-state working condition point according to the nonlinear model, wherein the linear parameter varying model expression is as follows:
$$\{ \begin{matrix}δ \dot{x} = {\overline{A}}_{i} δ x + {\overline{B}}_{i}^{c} δ {u}_{c} + {\overline{B}}_{i}^{e} δ {u}_{e} \\ δ y = {C}_{i} δ x\end{matrix} ,$$
where x is a state matrix corresponding to the state variables; u_{c} and uₑ are matrixes of the control input variables and the environment input variables, respectively; y is an output matrix; Āᵢ, Āᵢ^{c}, and B̅ᵢ^{c} are partial derivatives of the nonlinear model at an i-th steady-state working condition point; Ci represents an output matrix of the nonlinear model at the i-th steady-state operating condition point; and δ represents a deviation of a current numerical value of the variable following thereafter from a numerical value in the steady-state condition.

9. A modeling device of a floating wind turbine, comprising:
a variable acquiring module, configured to acquire pre-set state variables and input variables of the floating wind turbine, wherein the state variables are used to describe a state of the floating wind turbine, and the state variables comprise mechanical structure-related variables and electricity generation power-related variables; and the input variables comprise control input variables and environment input variables;
a first constructing module, configured to construct a nonlinear model based on the state variables and the input variables, wherein the nonlinear model comprises: a drivetrain subsystem model, a tower subsystem model, a semi-submersible floating platform subsystem model, and a mooring subsystem model; and
a second constructing module, configured to establish a control-oriented linear parameter varying model corresponding to the nonlinear model according to the nonlinear model, so as to control the floating wind turbine based on the control-oriented linear parameter varying model;
wherein the mechanical structure-related variables comprise a horizontal surge translation of the platform, a pitch tilting rotation angle of the platform, a pitch tilting rotation angle of the tower, and first order derivatives of the horizontal surge translation of the platform, the pitch tilting rotation angle of the platform, and the pitch tilting rotation angle of the tower with respect to time;
the electricity generation power-related variables comprise: a rotor speed, a pitch angle, and a generator electromagnetic torque;
the control input variables comprise: a reference pitch angle and a reference generator electromagnetic torque;
the environment input variables comprise: a horizontal reference wind speed measured at a nacelle of the floating wind turbine and a force of waves acting on the platform;
a state matrix corresponding to the state variables is expressed as:
x=[ωᵣ,β,Tₑ,θₜₚ,θₚₚ,ξₛᵤ,\dot{θ}ₜₚ,\dot{θ}ₚₚ,\dot{ξ}ₛᵤ]^{T},
where ωᵣ represents the rotor speed, β represents the pitch angle, Tₑ represents the generator electromagnetic torque, ξₛᵤ represents the horizontal surge translation of the platform, θₚₚ represents the pitch tilting rotation angle of the platform, θₜₚ represents the pitch tilting rotation angle of the tower, \dot{θ}ₜₚ, \dot{θ}ₚₚ, \dot{ξ}ₛᵤ respectively represent the first order derivatives of the pitch tilting rotation angle of the tower, the pitch tilting rotation angle of the platform, and the horizontal surge translation of the platform with respect to time; and
an input matrix corresponding to the input variables is expressed as:
u=[u_{c}^{T},uₑ^{T}]^{T}=[β_{ref},T_{ref},v_{w},F_{wave}]^{T},
where u_{c} and uₑ are matrixes of the control input variables and the environment input variables, respectively, β_{ref} represents the reference pitch angle, T_{ref} represents the reference generator electromagnetic torque, v_{w} represents the horizontal reference wind speed measured at the nacelle of the floating wind turbine, and F_{wave} represents a force of waves acting on the platform;
wherein the drivetrain subsystem model is configured to ensure a torque balance of the floating wind turbine; and
the step of constructing a nonlinear model based on the state variables and the input variables comprises:
extracting the rotor speed ωᵣ and the generator electromagnetic torque Tₑ among the electricity generation power-related variables; and establishing the drivetrain subsystem model according to the following formula:
\dot{ω}ᵣ=(Tᵣ−B_{d}ωᵣ−N_{g}Tₑ)/(Jᵣ+N_{g}²J_{g}),
where Tᵣ represents an aerodynamic torque of the floating wind turbine acquired from wind, B_{d} represents a damping constant, N_{g} represents a gear ratio, and Jᵣ and J_{g} are rotational inertia of the rotor and the generator, respectively.
wherein the tower subsystem model is a nonlinear model established according to all torques acting on a center of gravity of the tower of the floating wind turbine; and
the step of constructing a nonlinear model based on the state variables and the input variables further comprises:
constructing the tower subsystem model according to the following formulas:
$${\ddot{θ}}_{tp} = \frac{1}{{J}_{t}} ( {m}_{t} {gh}_{tc} sin {θ}_{tp} - {T}_{C} + {\int }_{0}^{{h}_{r}} {F}_{wind} ( 𝓏 ) d 𝓏 )$$
$${T}_{C} = {K}_{t} ( {θ}_{tp} - {θ}_{pp} ) + {B}_{t} ( {\dot{θ}}_{tp} - {\dot{θ}}_{pp} ) ,$$
where Jₜ is a rotational inertia of an equivalent tower; mₜ and h_{tc} represent a mass and a height of mass center of the tower; and Kₜ and Bₜ represent an elastic stiffness and damping system of the tower;
wherein the floating platform subsystem model is a nonlinear model established according to all moments acting on the floating platform of the floating wind turbine; and
the step of constructing a nonlinear model based on the state variables and the input variables further comprises:
acquiring the moments acting on the floating platform, wherein the moments comprise: a gravitational torque T_{C}, a buoyancy moment T_{B} of the floating platform, a mooring moment T_{M}, and an elasticity and damping moment T_{C} under coupling of the tower and the floating platform; and
constructing the floating platform subsystem model based on the moments,
wherein the floating platform subsystem model is expressed as:
$$\underline{{f}_{M}^{p} ( x , {u}_{c} , {u}_{e} ) = \sum {T}_{k} ( x , {u}_{c} , {u}_{e} ) / {J}_{p} . and}$$
$$\underline{{\sum }_{k} {T}_{k} ( x , {u}_{c} , {u}_{e} ) = {T}_{B} + {T}_{C} + {T}_{G} + {T}_{M}}$$
where Jₚ represents rotational inertia of the floating platform; and Tₖ is all the moments acting on the floating platform;
wherein the method further comprises:
acquiring an attribute information about the floating wind turbine, and calculating the gravitational torque according to the attribute information,
wherein the gravitational torque is expressed as: T_{G}=−mₚgh_{pc} sin θₚₚ; and mₚ and h_{pc} represent mass and height of mass center of the floating platform, respectively;
wherein the step of constructing a nonlinear model based on the state variables and the input variables further comprises:
acquiring a simplified model information about a mooring system of the floating wind turbine, and acquiring a force and a moment of a mooring cable in the mooring system acting on the floating platform based on the simplified model information, wherein one end of the mooring cable is connected to the platform, and another end being an anchor fixed to subsea soil;
extracting the horizontal surge translation in the state variables, and calculating a relationship between a change length of the mooring cable and the horizontal surge translation according to the horizontal surge translation, so as to establish a catenary equation;
calculating an angle between the mooring cable and the floating platform according to the catenary equation and parameters of the mooring cable; and
constructing the mooring subsystem model according to the input variables and the angle, wherein the mooring subsystem model is configured to represent a dynamic of the horizontal surge translation of the floating platform.

10. An electronic equipment, comprising a processor, a storage medium, and a bus, wherein the storage medium stores machine-readable instructions executable by the processor, wherein when the electronic equipment is running, the processor is in communication with the storage medium via the bus, and the processor executes the machine-readable instructions, so as to implement the steps of the method according to claim 1.

11. (canceled)

12. (canceled)

13. (canceled)

14. (canceled)

15. (canceled)

16. (canceled)

17. The electronic equipment according to claim 10, wherein the step of establishing a control-oriented linear parameter varying model corresponding to the nonlinear model according to the nonlinear model comprises:
establishing the linear parameter varying model of the floating wind turbine at a steady-state working condition point according to the nonlinear model, wherein the linear parameter varying model expression is as follows:
$$\{ \begin{matrix}δ \dot{x} = {\overline{A}}_{i} δ x + {\overline{B}}_{i}^{c} δ {u}_{c} + {\overline{B}}_{i}^{e} δ {u}_{e} \\ δ y = {C}_{i} δ x\end{matrix} ,$$
where x is a state matrix corresponding to the state variables; u_{c} and uₑ are matrixes of the control input variables and the environment input variables, respectively; y is an output matrix; Āᵢ, B̅ᵢ^{c}, and B̅ᵢ^{c} are partial derivatives of the nonlinear model at an i-th steady-state working condition point; Ci represents an output matrix of the nonlinear model at the i-th steady-state working condition point; and δ represents a deviation of a current numerical value of the variable following thereafter from a numerical value in the steady-state condition.
